(19) United States
(12) Patent Application Publication
(10) Pub. No.: US 2026/0218405 A1
(43) Pub. Date: Jul. 30, 2026

(54) AN ALUMINUM ELECTROLYSIS CELL

(71) Applicant: Central South University, Changsha, Hunan (CN)

(72) Inventors: Jie Li, Changsha, Hunan (CN); Ling Ran, Changsha, Hunan (CN); Hongliang Zhang, Changsha,Hunan (CN); Peijiu Geng, Changsha, Hunan (CN); Zhong Zou, Changsha, Hunan (CN); Fenggi Ding, Changsha, Hunan (CN); Shenghua Xiao, Changsha, Hunan (CN)

(73) Assignee: Central South University, Changsha, Hunan (CN)

(21) Appl. No.: 19/143,866

(22) PCT Filed: Jul. 8, 2024
(86) PCT No.: PCT/CN2024/104135

§ 371 Date: Jun. 26, 2025

(30) Foreign Application Priority Data
Jul. 10, 2023 (CN) 20231083876.X

(51) Int. Cl. C25C 3/12; C25C 3/22

(52) U.S. Cl. CPC C25C 3/125; C25C 3/22

(57) ABSTRACT

An aluminum electrolysis cell includes an central passage for gas/heat collection above its middle seam, the high-temperature melt and upper regions of the cell are divided into three gradient temperature zones: an inner insulation zone, an central passage, and an outer layer sealed insulation zone, this design maximizes heat retention and directs heat through flue gas via controlled exhaust from the central passage, overcoming limitations of traditional single-layer insulation, and anode carbon blocks, steel claws, and guide rods are enclosed within the outer layer sealed insulation zone, avoiding direct exposure to high-temperature corrosive flue gas, this facilitates ultra-low voltage energy-saving processes, flexible operation for renewable energy integration, and high-temperature flue gas waste heat recovery.

### TECHNICAL FIELD

The present invention relates to an aluminum electrolysis cell, and more particularly to a gradient thermal insulation aluminum electrolysis cell, in particular to a gradient thermal insulation sealed aluminum electrolytic cell, belonging to the technical field of aluminum electrolysis cells.

### BACKGROUND

The aluminum electrolysis cell is a core device to obtain primary aluminum by smelting. At present, the production of primary aluminum still relies on a Hall-Heroult method, that is, a cryolite is used as an electrolyte to dissolve alumina, and electrolysis reduction is performed in a high-temperature environment of about 930° C. to 950° C. The energy consumption of this method is high. For example, the AC comprehensive power consumption is about 13000 KWh/t-Al, meanwhile, the energy utilization rate is about 50%, which is relatively low, and most of the energy is dissipated into the surrounding environment in a thermal energy manner.

Generally, the current prebaked aluminum electrolysis cell includes components such as a tank body, a gas collector, an anode lifting device, a smoke exhaust and dust removal system, an anode conductive device (an anode steel claw group), and the like.

In the anode conductive structure of the current aluminum electrolysis cell, two groups of large busbar are generally arranged side by side along the length direction of the aluminum electrolysis cell. There are more than ten groups of anode carbon block groups composed of anode guide rods, anode steel claws and anode carbon blocks on two groups of large busbar in each aluminum electrolysis cell. The bottoms of anode carbon blocks are in contact horizontally with molten salt electrolyte in the lower shell of the aluminum electrolysis cell, and the current in the anode large busbars introduced into the electrolyte, so that the anode carbon blocks participate in thermo-electrochemical reaction. A gap is reserved between the inner side faces of the two sets of anode carbon blocks which are symmetrical to each other, and is generally referred to as a “middle seam”.

At present, the upper structure design of electrolytic cells is relatively rigid and semi-open, and most of the electrolytic cells are designed as bottom/side insulation type electrolysis cells, therefore about 35% of heat is dissipated from the side of the electrolysis cell, and more than 50% of heat is dissipated from the upper portion of the electrolysis cell. The mainly reason is that the air leakage amount of the the upper portion of the electrolysis cell is larger, most of the air enters the smoke tube from the slot cover plate gap, and the thermal insulation performance of the upper portion of the electrolysis cell is poor. The flue gas amount of one 400 KA electrolytic cell reaches about 10000 Nm³/h, the flue gas treatment amount is very large, and the temperature of the flue gas is low (below 200° C.), so that there is no value of waste heat recovery in the flue gas heat of the current aluminum electrolysis cell

While aluminum electrolysis is energy-intensive, it also contributes significantly to carbon emissions, especially due to indirect carbon emissions from the widespread use of thermal power generation. To promote low-carbon development in the aluminum electrolysis industry, it is essential to increase the proportion of new energy power used. Currently, most of the electricity for aluminum electrolysis comes from high-emission thermal power plants. Therefore, for the “electricity guzzler” of the aluminum electrolysis industry, the higher the proportion of new energy power used, the lower the carbon emissions will be. However, new energy generation has characteristics such as seasonality and volatility, which inevitably cause significant fluctuations in current load, impacting the thermal balance of electrolytic cells. How to achieve dynamic regulation of electrolytic cells under fluctuating current loads through heat dissipation adjustment is a technical challenge.

Therefore, aluminum electrolysis cells now face two significant challenges in terms of energy balance. On one hand, the cells need to effectively recover lost heat, indirectly reducing their energy consumption levels. On the other hand, while ensuring efficient waste heat recovery, precise and effective control of heat dissipation must be maintained to achieve dynamic thermal balance regulation under fluctuations in current load.

Based on the current structure of electrolytic cells, Chinese patent CN202011118864.5 proposes installing a heat exchanger on the side of the aluminum electrolytic cell to achieve waste heat recovery and dynamic adjustment of the cell walls. However, the heat lost from the side accounts for only about 35% of the total heat dissipation of the electrolytic cell, and the amount of waste heat recovered from the side is limited in terms of achieving flexible thermal regulation of the electrolytic cell. Moreover, the heat transfer area that can effectively collect heat and the range where waste heat can be utilized are restricted by the side structure, resulting in a more limited amount of heat collected, significant lag in heat collection, and thermal conductivity lag. This makes it difficult to adapt to changes in power supply due to variations in day and night loads. Additionally, the significant adjustment of the cell walls from the side is constrained by process requirements such as ensuring furnace stability, electrolyte composition, and changes in initial crystal temperature, making it challenging to achieve flexible thermal regulation under large current fluctuations. In contrast, the upper part of the cell loses more heat. How to effectively concentrate the heat lost from the upper part and achieve controllable heat dissipation is an important direction for achieving waste heat recovery, heat regulation, and low-energy development in aluminum electrolytic cells.

The Chinese patent application CN114016086A discloses a structure for an aluminum electrolysis cell using a waste heat boiler. This design retains the existing cathode melt pool furnace structure and anode carbon block steel claw group conductive structure of the aluminum electrolysis cell while referencing the design principles of waste heat boilers. It uses metal material inner flue vertical baffle plates, zoned isolation steel plates, outer insulation furnace walls, and upper horizontal insulation cover plates to divide the overall integrated anode operation space of the existing aluminum electrolysis cell into several relatively independent, smaller anode insulation operation compartment spaces that can accommodate multiple anode carbon blocks. After improvement, the internal flue of the aluminum electrolysis cell is equipped with negative pressure air output pipes and heat transfer pipe devices on the inner flue vertical baffle plates and zoned isolation steel plates inside the intermediate flue. These devices absorb and discharge the thermal energy from the exhaust gas and heat dissipation within the aluminum electrolysis cell to the waste heat utilization device for efficient waste heat recovery. However, the resulting insulation structure remains a traditional single-layer internal insulation structure, with the temperature in the anode operation area still being relatively high. This results in a large area where the temperature difference between the electrolysis cell and the external environment is significant, failing to effectively enhance the insulation performance of the aluminum electrolysis cell. Additionally, it keeps components such as anode rods and anode steel claws in a high-temperature environment, which is detrimental to extending their service life. Consequently, the temperature of the exhaust gas obtained is also lower, reducing its value for waste heat utilization.

Moreover, the heat transfer medium in the heat transfer pipes can be water or steam, posing obvious safety hazards to the aluminum electrolysis cell.

### SUMMARY OF THE INVENTION

In view of the shortcomings of the existing technology, the purpose of this invention is to provide a gradient insulation aluminum electrolytic cell, in order to better realize the thermal balance control of aluminum electrolytic cell.

Furthermore, this invention addresses the issue that existing aluminum electrolysis cells rely solely on a single internal insulation layer which is hard to achieve maximum sealing of heat emitted from the top. It also tackles the problem of direct corrosion of components such as the anode carbon blocks, anode steel claws, and anode guide rods by high-temperature flue gas, as well as the high flue gas emissions and low flue gas temperature caused by the upper heat dissipation structure, which hinders efficient utilization and reduces the efficiency of heat utilization in the upper part and the adjustability of upper heat dissipation. This can lead to unstable thermal balance during flexible operation of the electrolysis cell. The invention provides an aluminum electrolysis cell with a novel structure, particularly the upper part. By innovatively constructing the upper heat dissipation structure of the current aluminum electrolysis cell, setting up a gradient temperature distribution in the upper part, and efficiently concentrating the heat dissipated from the upper part, it enhances the recovery efficiency of residual heat in the upper part of the electrolysis cell, improves energy utilization, and enhances the controllability of thermal balance. This ultimately aims to further reduce energy consumption and power load under flexible operation conditions.

In order to solve the above technical problem, the technical solution of the present invention is as follows:
A gradient insulation aluminum electrolysis cell includes a cell body, multiple anode carbon block groups, and a sealing hood set on the top of the cell body; the cell body and the sealing hood form a gas collection chamber; the multiple anode carbon block groups are divided into 2 rows, and these 2 rows of anode carbon block groups are symmetrically distributed along the length of the cell body; each row contains multiple anode carbon blocks, with the anode guide rods of the anode carbon block groups extending upward through the sealing hood and reaching above it the top of the anode carbon blocks is covered with an inner insulation layer, and the anode carbon blocks extend into the electrolyte layer within the cell body; above the sealing hood, there is a main exhaust pipe, whose outlet end is connected to a negative pressure suction system inside the gas collection chamber, there are 2 first partition plates symmetrically distributed along the length of the cell body; the top end of the first partition plate is fixed to the sealing hood, while the bottom end extends into a middle seam and is located above the electrolyte layer within the cell body; the middle seam between the first partition plate and the adjacent anode carbon blocks is covered with an anode covering material; several first through-holes are set on the first partition plate; thus, the 2 first partition plates divide the gas collection chamber into one central passage and two outer layer sealed insulation zones symmetrically distributed on both sides of the central passage along the length of the cell body (i.e., divided into an outer layer sealed insulation zone, a central passage, and another outer layer sealed insulation zone, arranged sequentially along the width of the cell body). The central passage is connected to the main exhaust pipe.

Further, the first partition plate has fire resistance and thermal insulation properties.

The central passage for gas and heat collection is set above the middle seam of the anode carbon blocks in the aluminum electrolysis cell. Thus, the inner insulation layer along with two first partition plates divides the high-temperature melt area and above into three temperature gradient zones: the inner insulation zone (the area below the inner insulation layer), the central passage, and the outer layer sealed insulation zone (the temperature of these zones and passage decrease sequentially). This design allows as much heat dissipated from the upper part of the electrolysis cell to be carried away by flue gas and controlled to be discharged from the central passage through flue gas flow regulation, overcoming issues such as the difficulty of achieving maximum sealing of heat and flue gas emitted from the upper part with traditional single insulation layers. In this invention, the anode guide rod extends upward through the sealing hood and reaches above it, enclosing the anode carbon blocks and anode steel claws within the outer layer sealed insulation zone. The high-temperature flue gas generated by the electrolysis reaction is mainly discharged through the central passage, preventing direct exposure of the anode carbon blocks, steel claws, and guide rod to the high-temperature flue gas, which could cause corrosion. This creates conditions for ultra-low voltage energy-saving electrolysis processes, flexible operation processes oriented towards new energy consumption, and the utilization of residual heat from high-temperature flue gas for power generation.

The existing traditional aluminum electrolysis cells do not have the aforementioned first partition and other structures as described in this invention. The temperature differences across different areas of the upper part of the aluminum electrolysis cell are very small, while the temperatures in direct exposure areas such as anode carbon blocks, steel claws, and guide rods are relatively high, making them prone to corrosion; the overall temperature of the flue gas decreases, making it difficult to effectively concentrate the heat from the flue gas, resulting in a lower outlet temperature for the flue gas.

Optionally, the inner insulation layer can be made of current insulation material (such as anode covering material); or it can be made of current insulation cover plate.

Furthermore, multiple second partition plates are arranged along the length direction of the tank in the outer layer sealed insulation zone. These second partition plates are perpendicular to the length direction of the tank. The top end of the second partition plate is hinged to the sealing hood, while its bottom end extends downward to below the inner insulation layer and above the electrolyte layer within the tank. The gap between the second partition plate and the adjacent anode carbon block is covered with an anode covering material. Thus, multiple second partition plates divide the outer layer sealed insulation zone along the length direction of the tank into several sub-outer layer sealed insulation zones arranged sequentially. First through-holes are set on the first partition plates corresponding to each sub-outer layer sealed insulation zone, connecting these sub-outer layer sealed insulation zones with the central passage.

Thus, multiple first partition plates are set up in the outer layer sealed insulation zones of both the power input and output surfaces, dividing the air area above the anode into several sub-outer layer sealed insulation zones. This further divides the electrolyzer temperature zone into an inner insulation zone composed of molten aluminum, electrolyte melt, and the gas cavity below the anode, a high-temperature flue gas collection zone formed by the central passage, and several sub-outer layer sealed insulation zones between each first partition plate.

The second partition is set to divide the outer layer of the sealed insulation zone above the anode into several sub-outer layer of the sealed insulation zone in an orderly manner, so as to reduce the disordered flow of flue gas between each region, balance the system pressure and reduce the unorganized emission of flue gas during the operation of changing the electrode.

Generally, the temperature of the inner insulation zone lies within the normal high-temperature electrolysis zone, which may be 900° C.-950° C. of the existing conventional electrolyte system, and it is also applicable to low-temperature electrolysis. The temperature of the central passage ranges from 400° C.-650° C. The temperature of the sub-outer layer sealed insulation zones ranges from 250° C. to 400° C.

Optionally, the specific temperature value and temperature range of each zone can be obtain through a comprehensive design of factors including the aluminum electrolysis process requirements, the insulation structure of each zone, the thickness and strength of insulation layer and the size or opening of the first through-hole. During the operation of the electrolysis cell, the temperature can be adjusted by regulating the exhaust volume in the central passage, the opening of the first through-hole in the sub-outer layer sealed insulation zone as well as the thickness and covering method of the inner insulation layer. Therefore, the temperatures in each zone can reach the target range mentioned above and thereby ensure the normal operation of the aluminum electrolysis cell.

Furthermore, within the outer layer sealed insulation zone, a second partition plate is placed after every N group of anode carbon block groups, where N is an integer no less than 1. Preferably, N is between 2-4.

Optionally, the first partition plate is either a refractory and thermal-insulating plate or a composite plate including a steel material layer and a refractory and thermal-insulating layer.

Optionally, the first partition plate is one of the following plates: a steel plate, a refractory and thermal-insulating plate, a composite plate consisting of steel material as well as refractory and thermal-insulating material. Preferably, the first partition plate is a composite plate that includes a refractory and thermal-insulating layer and steel material layers bonded to the inner and outer surfaces of the refractory and thermal-insulating layer, offering both high strength as well as good refractory and thermal-insulating performance.

Preferably, the bottom end of the first partition plate is positioned equivalent to the top surface of the inner insulation layer on the top of the anode scrap within the cell body.

Optionally, the anode covering material is an existing and common anode covering material.

Furthermore, the second partition plate includes a first metal frame layer with both sides being sequentially covered, from inside to outside, by a first insulation layer and a second metal frame layer. A lifting ring is fixed to the top of the second partition plate, and a pin shaft matched with the lifting ring is set on the sealing hood. This configuration forms a multi-layer sandwich structure, offering both high strength and good insulation property. Additionally, it facilitates the installation of the second partition plate, providing it with a certain degree of freedom to sway, which ensures smooth operations such as anode replacement.

Optionally, the metal frame layer is made of metal sheets.

Furthermore, the cross-section of the central passage in the width direction of the cell is funnel-shaped. The funnel-shaped central passage is wide at the top and narrow at the bottom, allowing alumina ash to be gathered and fall into the electrolyte region effectively, thereby reducing waste of alumina raw material.

Furthermore, the first pipe opening is set on the sealing hood to connect the central passage with the main exhaust pipe. Preferably, there are multiple first pipe openings, which are arranged sequentially along the length of the sealing hood.

Preferably, on the top of the central passage, a top insulation board is set between the central passage and the sealing hood. A second pipe opening is set on the top insulation board. The central passage, the second pipe opening, the first pipe opening and the main exhaust pipe are sequentially connected. This configuration can strengthen the insulation for the central passage and reduce heat loss. Preferably, the top insulation board is made of insulation material with a thermal conductivity lower than 0.1 W/(m·K).

Preferably, a flow monitor is set between the outlet end of the main exhaust pipe and the negative pressure suction system.

Furthermore, an aluminum outlet is set on one end of the cell body and a third partition plate is set between the aluminum outlet and the adjacent anode carbon block group. The third partition plate is perpendicular to the length direction of the tank. The top end of the third partition plate is fixed to the sealing hood, while its bottom end extends downward below the inner insulation layer and above the electrolyte layer within the tank. The first partition plate extends along the length direction of the tank to the inner surface of the third partition plate. The third partition plate, the tank and the sealing hood form an aluminum outlet insulation zone. A second through-hole is set on the third partition plate to connect the aluminum outlet insulation zone with the central passage. The aluminum outlet is not sealed into the central passage but is instead placed in the aluminum outlet insulation zone. This design facilitates aluminum siphon operations and minimizes the impact of such operations on the thermal balance of aluminum electrolysis cell. Generally, the aluminum outlet insulation zone can be considered part of the outer layer sealed insulation zone, and the temperature of aluminum outlet insulation zone is equivalent to that of the outer layer sealed insulation zone.

Furthermore, to facilitate observation of the state of the central passage, an observation hole that can be opened as needed is set at the end of the central passage far from the aluminum outlet. To facilitate maintenance of the shell breaker and feeder placed in the central passage or to solve other related faults, an observation/maintenance hole that can be opened as needed may be set at corresponding positions to the first partition plate and the shell breaker and feeder.

Furthermore, the sealing hood includes a first hood fixed to the truss of the aluminum electrolysis cell and multiple second hoods detachably connected to the first hood. Each anode guide rod extends upward through the second hoods and reaches above the sealing hood. The first hood and the multiple second hoods form the sealing hood. Detachable brackets are set on the anode guide rods, and the brackets are set below the second hood. This configuration facilitates the smooth operation of anode replacement.

Preferably, the hood includes a second insulation layer. Both inner and outer surfaces of the second insulation layer are covered by a metal shell, which gives the hood good sealing and insulation properties. The shall functions as a highly sealed and strongly insulated outer insulation layer above the inner insulation layer, which provides insulation for the central passage and enhances the overall insulation performance of the aluminum electrolysis cell.

Optionally, the main exhaust pipe is set above the sealing hood, and optionally, the main exhaust pipe is set at the top of the sealing hood.

Optionally, the metal is either aluminum or steel.

Optionally, the insulation layer is composed of a composite insulation material with a low thermal conductivity. Preferably the material is one or more of aerogel, aluminum-silicate ceramic fiber mat, and similar materials.

Preferably, the top surface of the bracket is the same height as the bottom surface of the first hood.

Preferably, the first hood is overlapped on the second hood.

Preferably, a second hood is set above each anode carbon block group.

Optionally, the cross-section of the sealing hood in the width direction of the tank is trapezoidal or inverted U-shaped.

Optionally, the anode guide rod is provided with screw thread and the bracket is connected with the screw thread on the anode guide rod.

Furthermore, the gap between the anode guide rod and the sealing hood is sealed with a sealing ring, and the ring is movably fitted around the anode guide rod. This design can effectively seal the gap while allowing the anode rod to move up and down freely during anode adjustment.

Furthermore, an adjustment mechanism is set on the first partition plate for regulating the opening of the first through-hole. This allows for the adjustment of the through-hole's opening and ensures more precise control of the thermal balance.

Optionally, the adjustment mechanism includes a threaded rod, a threaded cylinder matched with the threaded rod, a drive motor set on the first partition plate, and two parallel slide rails placed on either side of the first through-hole on the first partition plate. A slide plate is slidably set on the two sliding rails. The drive motor is connected to the threaded cylinder, making the threaded cylinder rotate about its central axis. One end of the threaded rod extends into the threaded cylinder and is connected with the screw thread on the cylinder, while the other end of the threaded rod is fixed to the fixed base secured to the slide plate. The threaded rod is parallel to the slide rails. Thus, the drive motor can rotate the threaded cylinder, causing the threaded rod to move and thereby making the slide plate move along with the threaded rod, which allows for stepless adjustment of the opening of the first through-hole.

Preferably, the drive motor is a high temperature resistant motor.

Optionally, a cell shell is set on the side of the cell body. The sealing hood is welded to the shell, thereby covering the entire upper heat dissipation zone enclosed by the shell. Preferably, a gap (preferably wider than 10 mm) is provided between the sealing hood and the inner insulation layer.

Preferably, when the temperature of the outer layer sealed insulation zone is set relatively high (e.g., 320° C. to 400° C.), the anode guide rod of the anode carbon block group includes an aluminum first rod section above and a steel second rod section below. The steel-aluminum connection part between the first and second rod sections is above the outer layer sealed insulation zone, and the lower end of the second rod section is connected integrally to the anode steel claw. The aluminum rod section in the outer layer sealed insulation zone is replaced by a steel second rod section, ensuring that the steel-aluminum joint maintains its mechanical strength despite the high temperature. Furthermore, a high-conductivity material (with conductivity higher than that of steel, preferably a metal material) is embedded in the second rod section and/or the anode steel claw to reduces the overall resistance of the anode rod and the anode steel claw, facilitating aluminum electrolytic cell production with ultra low voltage and low energy consumption.

Optionally, the inner insulation layer is made of alumina material. In this case, enhancing the insulation performance of the outer layer sealed insulation zone as much as possible can minimize the thickness of the inner insulation layer. It can reduce the workload or even eliminate the need for material removal when replacing anode, thereby creating favorable conditions for automatic and unmanned anode replacement.

Compared with the prior art, at least some embodiments of the present invention have the following beneficial effects:
(1) At least some embodiments of the present invention enhance the insulation performance of the upper portion of aluminum electrolysis cell through innovations in the upper structure and gas collection structure of the cell, overcoming limitations such as the difficulty of achieving maximum sealing of heat emitted from the upper part with traditional single insulation layers. Additionally, it improves the controllability of heat dissipation from the upper portion of the aluminum electrolysis cell, ensuring better and easier thermal balance regulation for the cell. At the same time, it effectively reduces the corrosion caused by flue gas on components placed in the low-temperature insulation zone (i.e., the outer layer sealed insulation zone) such as anode carbon blocks, anode steel claws and anode guide rods, reducing oxidation loss of the anode carbon blocks while extending the service life of the anode steel claws and anode rods, thereby lowering the overall production cost of aluminum electrolysis.
(2) In at least some embodiments of the present invention, a full-length intermediate gas collection zone is adopted as a fuel above the middle seam of the aluminum electrolysis cell. It significantly reduces the likelihood of harmful and corrosive gas generated by the aluminum electrolytic anode escaping through slot cover plate gap into the surrounding environment and contacting with components such as anode carbon blocks, anode steel claws and anode guide rods, thereby effectively reducing the corrosive effects of flue gas on these components. Additionally, the total volume of flue gas is significantly reduced, and the concentration of pollutants in the flue gas is markedly increased, lowering the cost of flue gas purification and creating favorable conditions for carbon capture.
(3) At least some embodiments of the present invention incorporate thermal balance control measures with controllable heat dissipation, facilitating flexible production and enabling the utilization of renewable energy sources such as wind and solar power.
(4) In at least some embodiments of the present invention, the flue gas temperature at the outlet of the main exhaust pipe is increased to approximately 400° C.-500° C., creating favorable conditions for waste heat recovery and increasing the value of waste heat utilization in flue gas. For example, flue gas at the aforementioned temperature can be effectively used for waste heat power generation, thereby improving the energy efficiency in aluminum electrolysis process. The traditional flue gas temperatures are lower, making it difficult to achieve power generation through waste heat utilization.
(5) In at least some embodiments of the present invention, the flue gas emission of aluminum electrolysis cell is lower, reducing the burden and the cost on flue gas treatment.
(6) Compared with the prior art CN114016086A, the aluminum electrolysis cell in at least some embodiments of the present invention has better insulation performance and higher flue gas temperature, resulting in greater waste heat utilization value and creating better conditions for subsequent waste heat recovery. Furthermore, the aluminum electrolytic cell of the present invention does not involve heat conducting media such as water or steam, offering better security.
(7) The aluminum electrolysis cell of the present invention can effectively prevent substances such as CO₂ in the flue gas from diffusing to the upper part of the anode covering material. It enriches the substances such as CO₂, fluorides and sulfides in the flue gas, facilitating flue gas purification and carbon capture. It also helps improving the efficiency of treating harmful components in the flue gas, reducing diffusion proportion of the harmful components to the workshop.

### BRIEF DESCRIPTION OF THE DRAWINGS

FIG. 1 is a cross section view on the small surface (i.e., the width direction of the cell body) of a gradient thermal insulation sealed aluminum electrolysis cell according to the present invention.

FIG. 2 is a cross section view of the aluminum outlet on the large surface (i.e., the length direction of the cell body) of a gradient thermal insulation sealed aluminum electrolysis cell according to the present invention.

FIG. 3 is a cross section view of the flue on the large face of a gradient thermal insulation sealed aluminum electrolysis cell according to the present invention.

FIG. 4 is a three-dimensional schematic of the upper gas collection and insulation structure according to the present invention.

FIG. 5 is a cross section view of the intermediate gas collection zone along the width direction of the cell body according to the present invention.

FIG. 6 is a cross section view of a second partition plate according to the present invention.

FIG. 7a is a cross section view of a part of the sealing hood according to the present invention.

FIG. 7b is a cross section view of a part of another sealing hood according to the present invention.

FIG. 8a is a schematic of the structure of an anode metal component according to the present invention.

FIG. 8b is schematic of the structure of another anode metal component according to the present invention.

FIG. 8c is a semi-section view of another anode metal component according to the present invention.

FIG. 8d is schematic of the structure of another anode metal component according to the present invention.

FIG. 9a is a schematic of an adjustment mechanism according to the present invention (with the first through-hole fully open).

FIG. 9b is a schematic of an adjustment mechanism according to the present invention (with the first through-hole partially open).

FIG. 10 is a schematic showing the replacement state of an anode carbon block group according to the present invention (with the first hood and the second hood not overlapped).

FIG. 11 is a thermal-flow coupling simulation flowchart of the upper structure of an aluminum electrolysis cell according to the present invention.

In the figures: 1—central passage, 2—main exhaust pipe, 3—the first through—hole, 4—anode busbar, 5—anode metal conponent, 5001—anode guide rod, 5002—steel—aluminum connection part, 5003—anode steel claw, 5004—the first rod section, 5005—the second rod section, 5006—the first copper component, 5007—integrated structure of guide rod and steel claw, 5008—the second copper component, 6—sealing hood, 7—inner insulation layer, 8—anode carbon block (new anode), 9—molten aluminum, 10—cellwall, 11—insulation liner, 12—impervious material, 13—cell shell, 14—bottom impervious insulation liner, 15—cathode steel bar, 16—cathode carbon block, 17—molten aluminum, 18—anode gas cavity, 19—anode carbon block (prebaked anode), 20—outer layer sealed insulation zone, 21—sealing ring, 22—steel bar paste, 23—The second partition plate, 24—aluminum outlet, 25—shell breaker and feeder, 26—observation hole, 27—observation/maintenance hole, 28—flow monitor, 29—Negative pressure suction system, 30—the first pipe opening, 31—slide rail, 32—slide plate, 3201—fixed base, 33—threaded rod, 34—drive motor, 35—control unit, 36—Detachable bracket, 37—the third partition plate, 38—the second through—hole, 1001—top insulation board, 1002—the first partition plate, 1003—the second pipe opening, 2301—the First metal frame layer, 2302—the first insulation layer, 2303—the second metal frame layer, 6001—shell, 6002—the second insulation layer, 6003—the second hood, 6004—the first hood, 3401—threaded cylinder, 39—gas collection chamber.

### DETAILED DESCRIPTION OF THE EMBODIMENTS

The following will provide a detailed description of the present invention with embodiments. It should be noted that the embodiments of the present invention and the features shown in these embodiments should be combined with each another. Terms such as “upper,” “lower,” “left,” and “right” that appear in the following content are used to refer to the corresponding directions in the drawings and are not intended to impose any limitations to the structure.

### Embodiment 1

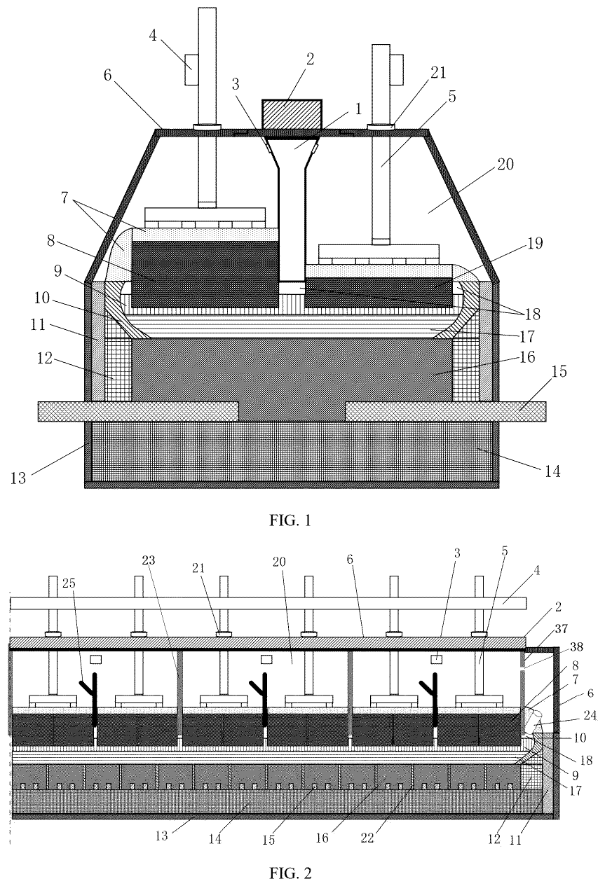

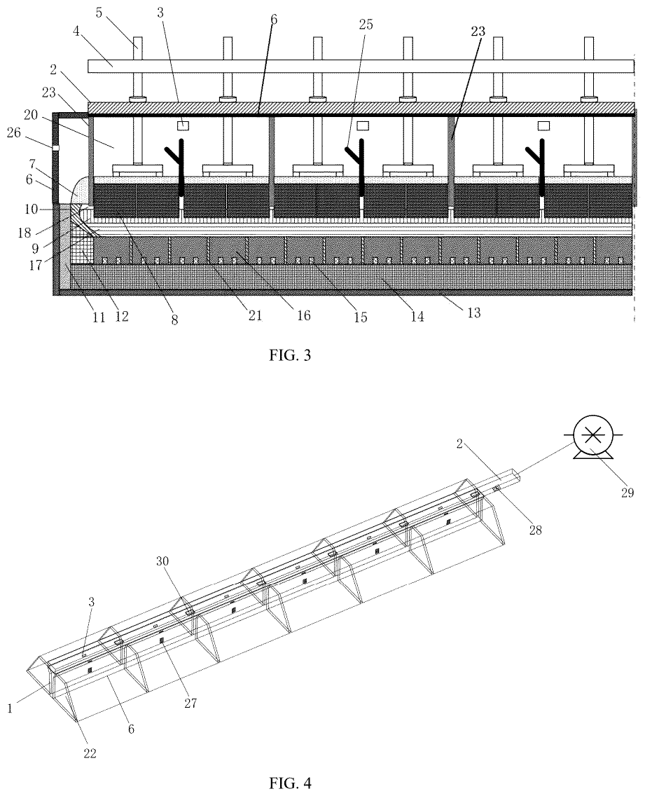

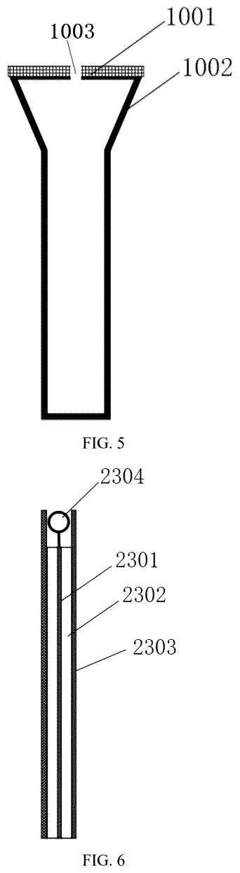

Referring to FIGS. 1 to 5, a gradient thermal insulation “sealed” aluminum electrolysis cell includes a cell body, multiple anode carbon block groups set directly above the cell body and a sealing hood 6 set on the top of the cell body; the cell body and the sealing hood 6 form a gas collection chamber 39 the multiple anode carbon block groups are divided into 2 rows, and these 2 rows of anode carbon block groups are symmetrically distributed along the length of the cell body; each row contains multiple anode carbon blocks, with the anode guide rods of the anode carbon block groups extending upward through the sealing hood 6 and reaching above it; the top of the anode carbon blocks is covered with an inner insulation layer 7, and the anode carbon blocks extend into the electrolyte layer 9 within the cell body; above the sealing hood 6, there is a main exhaust pipe 2, whose outlet end is connected to a negative pressure suction system 29; inside the gas collection chamber 39, there are 2 first partition plates 1002 symmetrically distributed along the length of the cell body; the top end of the first partition plate 1002 is fixed to the sealing hood 6, while the bottom end extends into a middle seam and is located below the top surface of the inner insulation layer above the prebaked anode and above the electrolyte layer 9 within the cell body; the middle seam between the first partition plate 1002 and the adjacent anode carbon blocks is covered with an anode covering material; several first through-holes 3 are set on the first partition plate 1002; thus, the 2 first partition plates 1002 divide the gas collection chamber into one central passage zone 1 and two outer layer sealed insulation zones 20 symmetrically distributed on both sides of the central passage zone 1 along the length of the cell body; each anode carbon block is in the outer layer sealed insulation zone 20; the central passage zone 1 is connected to the main exhaust pipe 2. The first partition plate has fire resistance and thermal insulation properties and is formed by sequentially layering a first steel layer, a thermal insulation material layer and a second steel layer. The inner insulation layer is made of alumina material. The main exhaust pipe 2 is set on the top of the sealing hood 6.

Multiple second partition plates 23 are arranged along the length direction of the tank in the outer layer sealed insulation zone 20. These second partition plates 23 are perpendicular to the length direction of the tank. The top end of the second partition plate 23 is hinged to the sealing hood 6, while its bottom end extends downward to below the inner insulation layer 7 and above the electrolyte layer 9 within the tank. The gap between the second partition plate 23 and the adjacent anode carbon block is covered with an anode covering material. Thus, multiple second partition plates 23 divide the outer layer sealed insulation zone 20 along the length direction of the tank into several sub-outer layer sealed insulation zones arranged sequentially. First through-holes 3 are set on the first partition plates 23 between the sub-outer layer sealed insulation zones and the central passage 1.

In the outer layer sealed insulation zone 20, a second partition plate 23 is placed after every two anode carbon block groups.

Referring to FIG. 6, the second partition plate 23 includes a first metal frame layer 2301 with both sides being sequentially covered, from inside to outside, by a first insulation layer 2302 and a second metal frame layer 2302. A lifting ring 2304 is fixed to the top of the second partition plate 23 and is securely connected to the top end of the first metal frame layer. A pin shaft matched with the lifting ring 2304 is set on the sealing hood 6. This design allows the second partition plate to be hung and fixed to the sealing hood while providing it a certain degree of freedom to sway from side to side, facilitating operations such as anode replacement.

The cross-section of the central passage 1 in the width direction of the cell is funnel-shaped which is wide at the top and narrow at the bottom,

A first pipe opening 30 is set on the sealing hood 6 to connect the central passage 1 with main exhaust pipe 2. On the top of the central passage 1, a top insulation board 1001 is set between the passage zone 1 and the sealing hood 6. A second pipe opening 1003 is set on the top insulation board 1001. The central passage 1, the second pipe opening 1003, the first pipe opening 30 and the main exhaust pipe 2 are sequentially connected. A flow monitor 28 is set between the outlet end of the main exhaust pipe 2 and the negative pressure suction system 29.

The top insulation board 1001 is made of insulation material with a thermal conductivity lower than 0.1 W/(m·K). There are multiple first pipe openings 30, which are arranged sequentially along the length of the sealing hood 6.

An aluminum outlet 24 is set on one end of the cell body and a third partition plate 37 is set between the aluminum outlet 24 and the adjacent anode carbon block group. The third partition plate 37 is perpendicular to the length direction of the tank. The top end of the third partition plate 37 is fixed to the sealing hood 6, while its bottom end extends downward below the inner insulation layer 7 and above the electrolyte layer 9 within the tank. The first partition plate 1002 extends along the length direction of the tank to the inner surface of the third partition plate 37. The third partition plate 37, the tank, and the sealing hood 6 form an aluminum outlet insulation zone. A second through-hole 38 is set on the third partition plate 37 to connect the aluminum outlet insulation zone with the central passage 1.

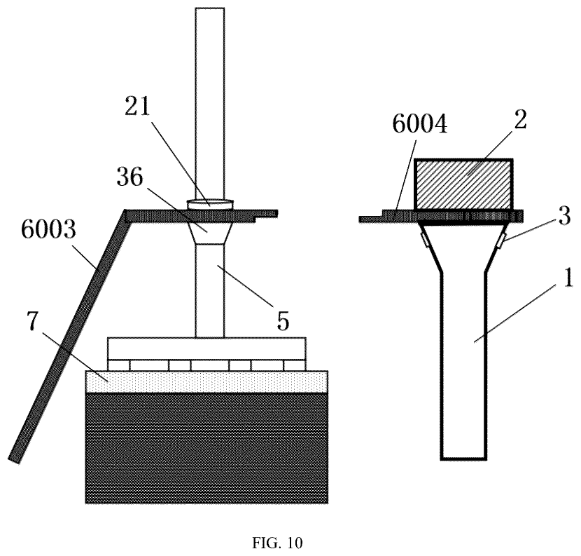

Referring to FIG. 10, the sealing hood 6 includes a first hood 6004 fixed to the truss of the aluminum electrolysis cell and multiple second hoods 6003 detachably overlapping the first hood 6004. Each anode guide rod extends upward through the second hoods 6003 and reaches above the sealing hood 6. The first hood 6004 and the multiple second hoods 6003 together form the sealing hood 6. Detachable brackets 36 are set on the anode guide rods, and the brackets 36 are set below the second hoods 6003. During anode replacement, the residual anode is lifted, and the corresponding second hood is raised by the bracket. Subsequently, a new anode carbon block group is prepared with pre-installed brackets and required second hoods, the new anode group is then lifted and installed into the designated position, ensuring the second hood overlaps with the first hood.

The hood includes a second insulation layer 6002. Both inner and outer surfaces of the second insulation layer are covered by a metal shell 6001. The second hoods 6003 overlap the first hood 6004.

The top surface of the bracket 36 is the same height as the bottom surface of the first hood 6004.

A second hood 6003 is set above each anode carbon block group. The insulation layer is composed of aluminum-silicate ceramic fiber mat. The thermal insulation material layer is also made of aluminum-silicate ceramic fiber mat.

The gap between the anode guide rod and the sealing hood 6 is sealed with a sealing ring 21, and the sealing ring 21 is movably fitted around the anode guide rod.

Referring to FIG. 9, an adjustment mechanism is set on the first partition plate 1002 for regulating the opening of the first through-hole 3. The adjustment mechanism includes a threaded rod 33, a threaded cylinder 3401 matched with the threaded rod 33, a drive motor 34 sat on the first partition plate 1002, and two parallel slide rails 31 placed on either sides of the first through-hole 3 on the first partition plate 1002, and a control unit 35. A slide plate 32 is slidably set on the two slide rails 31. The drive motor 34 is drivingly connected to the threaded cylinder 3401, making the threaded cylinder 3401 to rotate about its central axis. One end of the threaded rod 33 extends into the threaded cylinder 3401 and is connected with the screw thread on the cylinder, while the other end of the threaded rod 33 is fixed to a fixed base 3201 secured to the slide plate 32. The threaded rod 33 is parallel to the slide rails 31. The control unit is electrically connected to the drive motor to facilitate remote or automated control. A similar adjustment mechanism is also set on the third partition plate 37 to regulate the opening of the second through-hole 38.

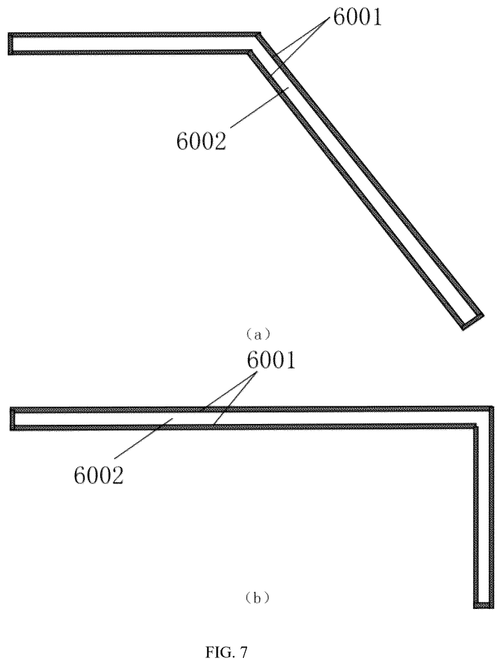

Referring to FIG. 7a, the cross-section of the sealing hood in the width direction of the tank is trapezoidal. Alternatively, as another embodiment, the cross-section of the sealing hood in the width direction of the cell body is inverted U-shaped, with the cross-section of the second hood being inverted L-shaped, as shown in FIG. 7b.

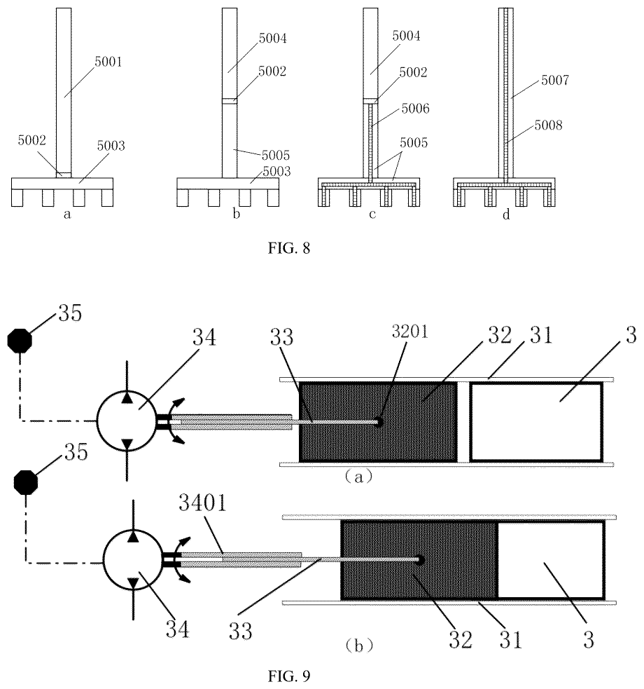

Referring to FIG. 8a, the anode carbon block group includes an anode guide rod 5001, an anode steel claw 5003 connected to the lower end of the anode guide rod and an anode carbon block fixed to the anode steel claw.

Referring to FIG. 8b, when the temperature of the outer layer sealed insulation zone is set relatively high (e.g., 320° C. to 400° C.), the anode guide rod of the anode carbon block group includes an aluminum first rod section 5004 above and a steel second rod section 5005 below. The steel-aluminum connection part 5002 between the first and second rod sections is above the outer layer sealed insulation zone, and the lower end of the second rod section 5005 is connected integrally to the anode steel claw 5003.

Referring to FIG. 8c, a first copper component 5006 is embedded within the second rod section. Optionally, the anode guide rod is made of steel, with its lower end integrally connected to the anode steel claw to form an integrated guide rod-steel claw structure 5007. A second copper component 5008 is embedded within the integrated structure, as shown in FIG. 8d, reducing additional work caused by steel-aluminum processing.

To facilitate observation of the intermediate gas collection zone, an observation hole 26 is set on the sealing hood at the end of the intermediate gas collection zone far from the aluminum outlet, a movable door is installed at the observation hole for opening when necessary. To facilitate maintenance of the shell breaker and feeder 25 placed in the intermediate gas collection zone or to address other related faults, observation/maintenance holes 27 that can be opened as needed are set on the side walls of the intermediate gas collection zone along its length, corresponding to the positions of the shell breaker and feeder, movable doors are installed at the observation/maintenance holes 27 for access during observation or maintenance.

The specific temperature values and ranges of the three insulation zones in the gradient insulation system can be achieved through comprehensive design of aluminum electrolysis process conditions, insulation structures, insulation layer thickness and strength, opening of the first through-hole in the outer layer sealed insulation zone, and other factors, during cell operation, adjustments such as regulating the exhaust volume in the intermediate gas collection zone, adjusting the opening of the first through-hole, and modifying the thickness and coverage of the inner insulation layer ensure that the temperatures in each zone reach the desired target ranges.

### Application Embodiment

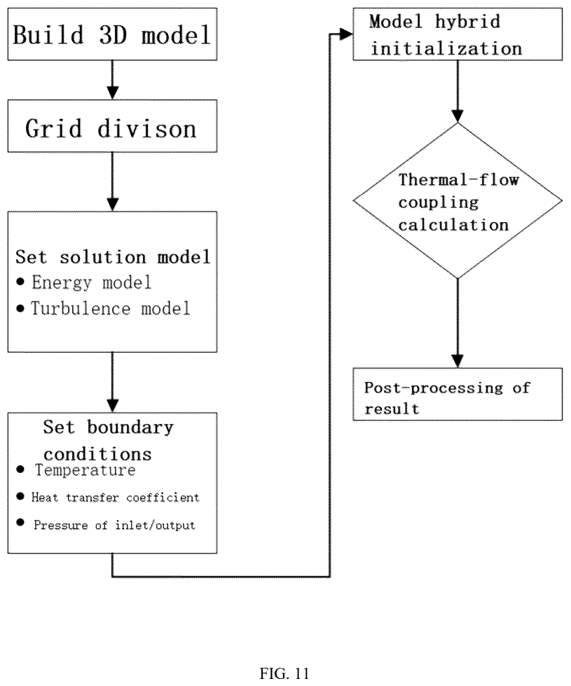

Taking a 400 kA aluminum electrolysis cell with the structure described in Embodiment 1 as an example, a full-length intermediate gas collection zone is set above the middle seam of the anode, an inner insulation layer equivalent to conventional insulation materials is placed above the anode, a highly sealed and strongly insulated sealing hood is installed above the inner insulation layer, enhancing both the insulation of the intermediate gas collection zone and the overall thermal performance of the cell; second partition plates are set between every two or more anode groups on the incoming and outgoing current sides, dividing the air space above the anodes into multiple sub-outer layer sealed insulation zones . . . this configuration partitions the cell into three temperature zones: the inner insulation zone (composed of molten aluminum and electrolyte), the intermediate high-temperature gas collection zone (constructed as a full-length gas collection duct), and multiple sub-outer layer sealed insulation zones formed between air barrier plates; adjustable first through-holes are set between the sub-outer anode sealed insulation zones and the high-temperature gas collection zone, multiple first flue gas openings are set on the sealing hood above the intermediate gas collection zone, connecting it to the upper main exhaust pipe, a flow monitor is installed on the outlet section of the main exhaust pipe, which is connected to an external negative pressure suction system. Using the modeling and simulation workflow shown in FIG. 11 on the ANSYS Fluent platform, a thermal-flow coupling numerical simulation was performed on the cell melt and upper structure, material properties such as density, specific heat capacity, and thermal conductivity were assigned to each component, boundary conditions included a fixed temperature of 950° C. for the melt zone, a convective heat transfer coefficient of 30 W/(m²·°C.) and ambient temperature of 40° C. for the cell shell and outer hood surfaces, a pressure outlet at the main exhaust pipe, and a pressure inlet with ambient temperature of 40° C. at the hood gaps. The simulation results showed an average temperature of 950° C. in the inner insulation zone, approximately 520° C. in the intermediate gas collection zone, and approximately 275° C. in the outer layer sealed insulation zone; the average flue gas temperature at the outlet of the main exhaust pipe was about 422° C., demonstrating a significant temperature gradient between the central passage and the outer layer sealed insulation zone, the elevated temperature in the central passage enhances the flue gas outlet temperature, improving its waste heat utilization value. In contrast, conventional 400 kA aluminum electrolysis cells exhibit flue gas temperatures below 200° C. at the main exhaust pipe outlet (refer to: Light Metals Journal, 2019, Issue 4, DOI:10.13662/j.cnki.qjs.2019.04.006). The flue gas flow rate at the outlet of the main exhaust pipe in the present invention is 4502 m³/h, approximately 40% of that in conventional cells, indicating effective concentration of flue gas heat for waste heat power generation. For this 400 kA cell under normal current intensity, the negative pressure at the main exhaust pipe outlet is approximately −500 Pa with a flow rate of 4502 m³/h; when the current increases by 15%, adjusting the negative pressure to −552 Pa and flow rate to 5162 m³/h maintains the melt temperature between 947° C. and 950° C., thus, the aluminum electrolysis cell of the present invention enables flexible operation without adjusting other process parameters, simplifying thermal balance regulation; in contrast, conventional cells require complex adjustments to parameters such as anode-cathode distance, insulation layer thickness, and exhaust flow rate to achieve thermal balance.

The above embodiment is illustrative of the present invention and not intended to limit it. Those skilled in the art should understand that the invention is not confined to the embodiment. The described embodiment and specifications explain the operational principles of the invention, various modifications and improvements falling within the scope of the invention, as defined by the appended claims and their equivalents, are possible.

1. An aluminum electrolysis cell, comprising a cell body, multiple anode carbon block groups, and a sealing hood set on top of the cell body, wherein the cell body and the sealing hood form a gas collection chamber; the multiple anode carbon block groups are divided into two rows symmetrically distributed along the length of the cell body, each row comprising multiple anode carbon block groups; anode guide rods of the anode carbon block groups extend upward through the sealing hood and above it; tops of the anode carbon blocks are covered with an inner insulation layer, and the anode carbon blocks extend into an electrolyte layer within the cell body; a main exhaust pipe is set above the sealing hood, with its outlet connected to a negative pressure suction system characterized in that: the gas collection chamber includes two first partition plates symmetrically distributed along the length of the cell body, the first partition plates having refractory and thermal insulation properties; top ends of the first partition plates are fixed to the sealing hood, and bottom ends extend into the middle seam above the electrolyte layer; gaps between the first partition plates and adjacent anode carbon blocks are covered with anode covering material; the first partition plates are provided with multiple first through-holes, dividing the gas collection chamber into one central passage and two outer layer sealed insulation zones symmetrically distributed along both sides of the central passage the central passage is connected to the main exhaust pipe.

2. The aluminum electrolysis cell according to claim 1, characterized in that: multiple second partition plates are arranged along the length direction of the tank in the outer layer sealed insulation zone the second partition plates being perpendicular to the length direction of the tank; top ends of the second partition plates are hinged to the sealing hood and bottom ends extend downward below the inner insulation layer and above the electrolyte layer; gaps between the second partition plates and adjacent anode carbon blocks are covered with anode covering material, dividing the outer layer sealed insulation zone into multiple sub-outer layer sealed insulation zones; first through-holes are set on the first partition plates corresponding to each sub-outer layer sealed insulation zone.

3. The aluminum electrolysis cell according to claim 2, characterized in that: within the outer layer sealed insulation zone a second partition plate is placed after every N group of anode carbon block groups, where N is an integer no less than 1.

4. The aluminum electrolysis cell according to claim 2, characterized in that: the second partition plate includes a first metal frame layer, with both sides being sequentially covered, from inside to outside, by a first insulation layer and a second metal frame layer.

5. The aluminum electrolysis cell according to claim 2, characterized in that: a lifting ring is fixed to the top of the second partition plate and a pin shaft matching the lifting ring is set on the sealing hood

6. The aluminum electrolysis cell according to claim 1, characterized in that: a first pipe opening is set on the sealing hood to connect the central passage with main exhaust pipe

7. The aluminum electrolysis cell according to claim 6, characterized in that: on the top of the central passage a top insulation board is set between the central passage and the sealing hood a second pipe opening is set on the top insulation board the central passage the second pipe opening the first pipe opening and the main exhaust pipe are sequentially connected.

8. The aluminum electrolysis cell according to claim 1, characterized in that: a flow monitor is set between the outlet end of the main exhaust pipe and the negative pressure suction system.

9. The aluminum electrolysis cell according to claim 1, characterized in that: an aluminum outlet is set on one end of the cell body; a third partition plate is set between the aluminum outlet and the adjacent anode carbon block group, the third partition plate is perpendicular to the length direction of the tank; a top end of the third partition plate is fixed to the sealing hood and a bottom end extends downward below the inner insulation layer and above the electrolyte layer within the tank; the first partition plate extends along the length direction of the tank to the inner surface of the third partition plate the third partition plate cell body, and sealing hood form an aluminum outlet insulation zone; a second through-hole is set on the third partition plate to connect the aluminum outlet insulation zone with the central passage

10. The aluminum electrolysis cell according to claim 1, characterized in that: the sealing hood includes a first hood fixed to the cell truss and multiple second hoods detachably connected to the first hood each anode guide rods extend upward through the second hoods and reaches above the sealing hood the first hood and the multiple second hoods form the sealing hood; detachable brackets are set on the anode guide rods below the second hoods a top surface of the brackets is the same height as the bottom surface of the first hood.

11. The aluminum electrolysis cell according to claim 10, characterized in that: the hood includes a second insulation layer both inner and outer surfaces of the second insulation layer are covered by a metal shell

12. The aluminum electrolysis cell according to claim 1, characterized in that: the gap between the anode guide rod and the sealing hood is sealed with a sealing ring and the sealing ring is movably fitted around the anode guide rod.

13. The aluminum electrolysis cell according to claim 1, characterized in that: an adjustment mechanism is set on the first partition plate for regulating the opening of the first through-hole

14. The aluminum electrolysis cell according to claim 1, characterized in that: the adjustment mechanism includes a threaded rod a threaded cylinder matched with the threaded rod a drive motor on the first partition plate, and two parallel slide rails placed on either sides of the first through-hole a slide plate is slidably set on the two slide rails the drive motor is drivingly connected to the threaded cylinder making the threaded cylinder rotate about its central axis; one end of the threaded rod extends into the threaded cylinder and is connected with the screw thread on the cylinder, while the other end of the threaded rod is fixed to fixed base secured to the slide plate the threaded rod is parallel to the slide rails.

15. The aluminum electrolysis cell according to claim 1, characterized in that: the first partition plate is either a refractory and thermal-insulating plate or a composite plate including a steel material layer and a refractory and thermal-insulating layer.
